(19) United States
(12) Patent Application Publication
(10) Pub. No.: US 2012/0126570 A1
(43) Pub. Date: May 24, 2012

(54) DOOR TRIM

(75) Inventors: Kentaro NAGAMURA, Shizuoka-ken (JP); Taku YAMAUCHI, Shizuoka-ken (JP); Ryusei MIZUTO, Shizuoka-ken (JP)

(73) Assignee: SUZUKI MOTOR CORPORATION, Shizuoka-ken (JP)

(21) Appl. No.: 13/289,810

(22) Filed: Nov. 4, 2011

(30) Foreign Application Priority Data
Nov. 19, 2010 (JP) 2010-258839

(51) Int. Cl. B60R 13/02

(52) U.S. Cl. 296/146.7

(57) ABSTRACT

A door trim includes a pocket opened at an upper side thereof and capable of housing a sheet shaped article, and a stepped portion being provided at one end portion, in a door longitudinal direction, of a pocket bottom portion, and protruding upward. The door trim is compatible with any state of: a first housing state in which the sheet shaped article in a tilted state is placed on an upper surface of the stepped portion and on the other end portion, in the door longitudinal direction, of the pocket bottom portion, and a second housing state in which another sheet shaped article larger than the sheet shaped article is vertically placed on the pocket bottom portion but not on the stepped portion.

### FIELD OF THE INVENTION

The present invention relates to a door trim including a pocket opened at an upper side thereof and capable of housing a sheet shaped article.

### BACKGROUND OF THE INVENTION

As a door trim provided with a pocket, as disclosed in Japanese Unexamined Utility Model Publication No. 2-117938, there has been a technique in which a partition part is provided on a pocket bottom portion, the partition part being switchable between a standing state and a folded state in accordance with the size of an article to be housed, so that the door trim is compatible with housing of multiple articles having different sizes.

Furthermore, as disclosed in Japanese Unexamined Utility Model Publication No. 60-110050, there has been a technique in which a beverage container housing portion is provided in the pocket, the beverage container housing portion including an upper half set to have a larger diameter than that of a lower half thereof, so that both a small beverage container and a large beverage container can be housed without rattling.

### BRIEF SUMMARY OF THE INVENTION

However, in the technique of Japanese Unexamined Utility Model Publication No. 2-117938, the partition part has to be made to stand from or to be folded on the pocket bottom portion in accordance with the size of an article to be housed. The standing operation and folding operation on the partition part are annoying tasks for the occupant.

In addition, in the technique of Japanese Unexamined Utility Model Publication No. 60-110050, the housing space for articles to be housed other than for the beverage containers cannot be changed in accordance with the size of the articles.

The present invention has been made in view of the above-described circumstances. An object of the present invention is to provide a door trim which is compatible with any of housing states in a pocket for a sheet shaped article and for another sheet shaped article having a different size from that of the sheet shaped article, and by which an operation to switch a part of the pocket into the former state or the latter state is no longer necessary, so that the task of the occupant can be reduced.

An aspect of the present invention is a door trim including: a pocket opened at an upper side thereof and capable of housing a sheet shaped article; and a stepped portion being provided at one end portion, in a door longitudinal direction, of a pocket bottom portion, and protruding upward. The door trim is compatible with a first housing state in which the sheet shaped article is placed in a tilted state on an upper surface of the stepped portion and on the other end portion, in a door longitudinal direction, of the pocket bottom portion, and a second housing state in which another sheet shaped article larger than the sheet shaped article is vertically placed on the pocket bottom portion, but not on the stepped portion.

By the above-described configuration, the sheet shaped article is placed on the upper surface of the stepped portion and on the other end portion, in the door longitudinal direction, of the pocket bottom portion. Therefore, the sheet shaped article can be housed in the tilted state in the door longitudinal direction.

For example, when a pocket structure does not include the stepped portion (i.e., a structure in which the pocket bottom portion is flat), and a part of the door trim is positioned close to a lower surface of the pocket bottom portion, in this structure, the length, in the door longitudinal direction, of the pocket has to be shortened so that the pocket can avoid interference with the part of the door trim, or the position of the pocket bottom portion has to be shifted upward to avoid the interference with the part of the door trim. This brings about a problem in that the length, in the door longitudinal direction, of the housing space of the pocket is shortened, and a further problem in which the height dimension of the housing space is shortened, thereby reducing the capacity of the pocket.

On the other hand, the above-described configuration of the present invention enables a bottom space to be formed below the stepped portion. The part of the door trim is housed in the bottom space, and the stepped portion is disposed above the part of the door trim. Therefore, the aforementioned problems can be avoided.

Furthermore, according to the above-described configuration of the present invention, another sheet shaped article larger than the sheet shaped article housed in the tilted state in the door longitudinal direction, can be vertically placed and housed on the pocket bottom portion, but not on the stepped portion.

That is to say, the following states are both compatible: the first housing state in which the sheet shaped article is placed in the tilted state on the upper surface of the stepped portion and on the other end portion, in the door longitudinal direction, of the pocket bottom portion; and the second housing state in which another sheet shaped article larger than the sheet shaped article is vertically placed on the pocket bottom portion but not on the stepped portion. Furthermore, an operation to switch a part of the pocket into the former state or the latter state is no longer necessary. This can reduce the tasks of the occupant.

In the present invention, the stepped portion is formed to have a longitudinal cross section in an L shape, and a fixing portion for fixing a door trim main body to a door panel is disposed in the bottom space surrounded by the stepped portion. Therefore, the following effects can be achieved.

Since the fixing portion for fixing the door trim main body to the door panel is disposed in the bottom space surrounded by the stepped portion, the need to change the position of the fixing portion in relation to the pocket is eliminated, and the freedom of disposing the fixing portion can be improved. Furthermore, by disposing the fixing portion at a lowermost corner portion of the door trim of which lifting or the like is likely to occur, the strength of fixing the door trim to the door panel can be sufficiently secured.

In the present invention, the fixing portion is a clip base fixed to the door panel with a clip. Therefore, the following effects can be achieved.

The need to change the position of the clip base in relation to the pocket is eliminated, and the freedom of disposing the clip base can be improved. Furthermore, by disposing the clip base at the lowermost corner portion of the door trim of which lifting or the like is likely to occur, the strength of fixing the door trim to the door panel can be sufficiently secured.

In the present invention, a wall portion of the pocket rising from the one end portion, in the door longitudinal direction, at the upper surface of the stepped portion inclines more to an inner side of the pocket at a higher position of the wall portion. Therefore, the following effects can be achieved.

In a case in which the sheet shaped article is housed in the tilted state in the pocket as described above, the sheet shaped article can be housed by guiding the sheet shaped article to the inclined wall and along the inclined wall. Therefore, the housing operation into the pocket can be performed simply and surely.

In the present invention, the other end portion, in the door longitudinal direction, of the pocket bottom portion is extended in the door longitudinal direction to form a beverage container housing portion, and a partition wall is provided upright between the beverage container housing portion and the pocket bottom portion. Therefore, the following effects can be achieved.

The partition wall makes it possible to inhibit the movement of the sheet shaped article to the beverage container housing portion side. Furthermore, even in a case in which the another sheet shaped article having a large size is vertically placed and housed on the pocket bottom portion, but not on the stepped portion, the stepped portion and the partition wall can prevent movement of the another sheet shaped article inside the pocket when the door is opened and closed, and when the vehicle is suddenly accelerated or decelerated.

In the present invention, a top surface of the partition wall and the upper surface of the stepped portion are positioned at approximately a same position in a vertical direction. Therefore, the following effects can be achieved.

When a beverage container is not housed in the beverage container housing portion, the housing space of the pocket is increased to the beverage container housing portion. In a case in which a far larger sheet shaped article than the another sheet shaped article having a large size is to be housed, such a sheet shaped article can be placed and housed in such a manner as to be bridged on the partition wall and on the stepped portion.

For example, in a structure not including one of the partition wall and the stepped portion, only the other of the partition wall and the stepped portion protrudes upward from the pocket bottom portion. Accordingly, the far larger sheet shaped article cannot be housed stably. However, the above-described configuration of the present invention enables the far larger sheet shaped article to be housed stably as described above.

The present invention can provide a door trim which is compatible with any of housing states in a pocket for a sheet shaped article and for another sheet shaped article having a different size from that of the sheet shaped article, and by which an operation to switch a part of the pocket into the former state or the latter state is no longer necessary, so that the tasks of the occupant can be reduced.

### BRIEF DESCRIPTION OF THE DRAWINGS

FIG. 1 is a side view of a front half of an automobile.

FIG. 2 is a view of a door seen from the inner side of a vehicle compartment.

FIG. 3 is a view of a door trim seen from the back side (i.e., the outer side of the vehicle compartment).

FIG. 4 is a perspective view of the door trim seen from the inner side of the vehicle compartment.

FIG. 5 is a perspective view of a pocket member.

FIG. 6 is a view of a pocket seen from the back side (i.e., the outer side of the vehicle compartment).

FIG. 7 is a sectional view taken along the line A-A in FIG. 4, showing a first housing state.

FIG. 8 is a sectional view taken along the line A-A in FIG. 4, showing a second housing state.

FIG. 9 is a sectional view taken along the line A-A in FIG. 4, showing a larger sheet shaped article housed in a tilted state.

### DETAILED DESCRIPTION OF THE INVENTION

Hereinafter, a mode for practicing the present invention will be described based on the drawings.

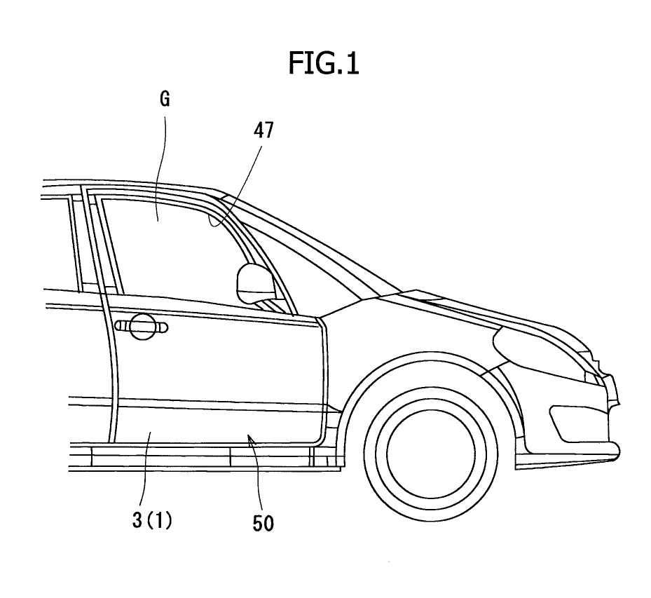

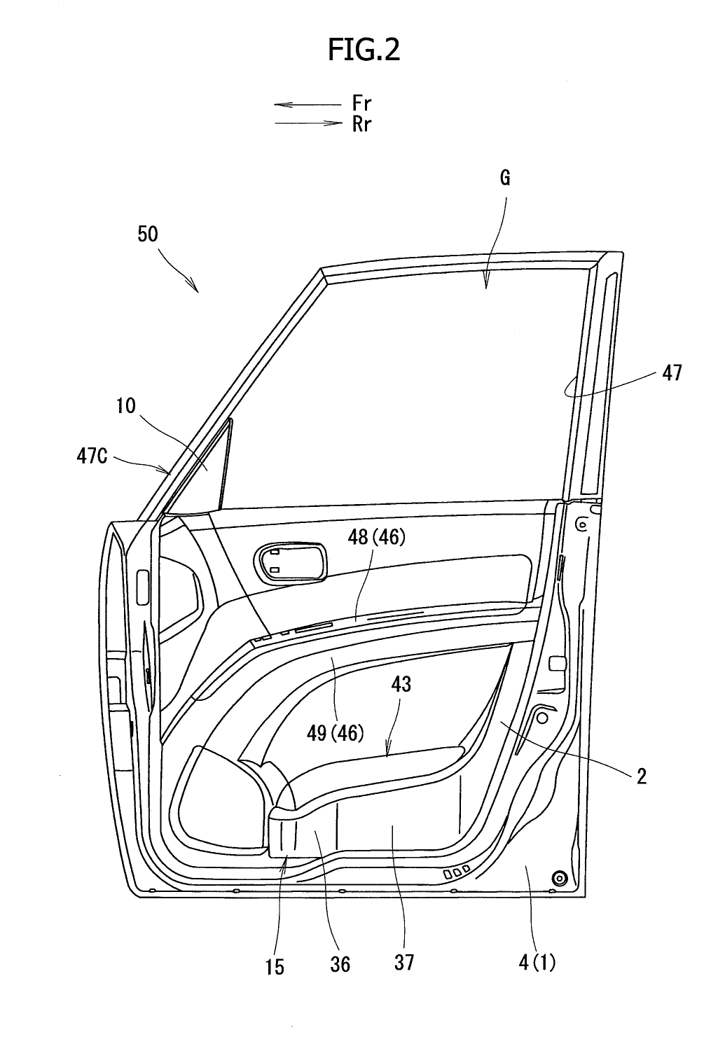

FIGS. 1 and 2 show a front door 50 provided on a side portion of a vehicle body of an automobile in such a manner that the front door 50 can be opened and closed freely. The front door 50 includes a door panel 1 having a window opening 47 formed in an upper portion thereof, and a door trim 2 covering a portion of the door panel 1 below the window opening 47. The window opening 47 of the door panel 1 is provided with a window glass G which can be raised and lowered. A mirror garnish 10 is attached to a corner portion 47C on a lower front side of the window opening 47. The mirror garnish 10 covers and hides a side mirror fixing portion at the door panel 1 and a screw for fixing a side mirror to the side mirror-fixing portion.

[Structure of Door Panel 1]

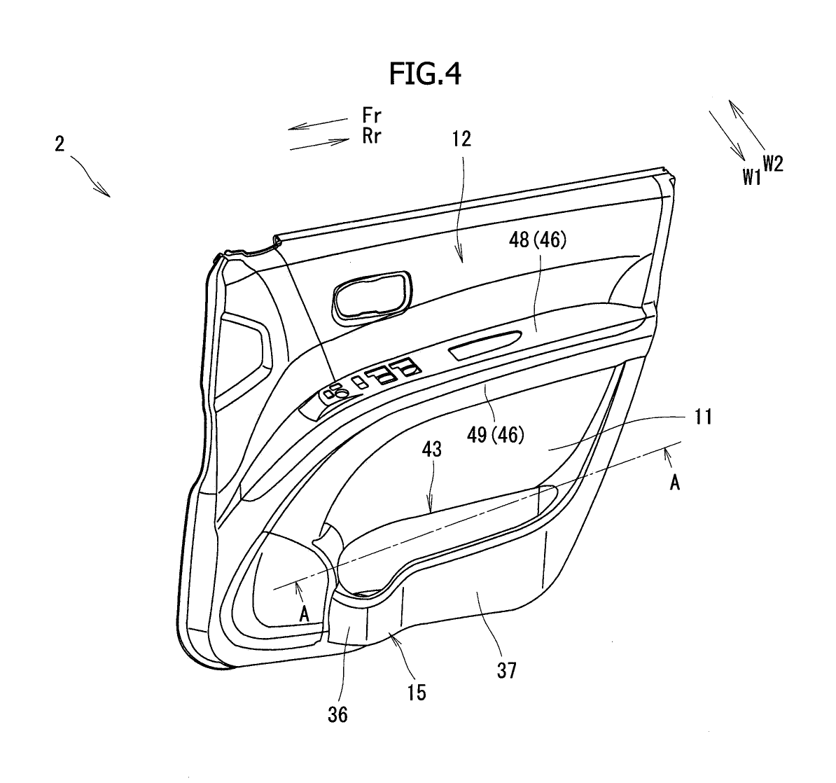

The door panel 1 includes an outer panel 3 on an outer side W2 of the vehicle compartment (see FIG. 4) and an inner panel 4 on an inner side W1 of the vehicle compartment. The outer panel 3 and the inner panel 4 are bonded to each other at their peripheral portions. Inner portions of the outer panel 3 and the inner panel 4, which are on the inside of the peripheral portions, face each other at an interval therebetween. Furthermore, an inner weather strip (not shown) made of a rubber-like elastic material for sealing a gap between the inner panel 4 and the window glass G, is attached to an attachment flange at an upper end portion of the inner panel 4. An outer weather strip (not shown) made of a rubber-like elastic material for sealing a gap between the outer panel 3 and the window glass G, is attached to an attachment flange at an upper end portion of the outer panel 3.

[Structure of Door Trim 2]

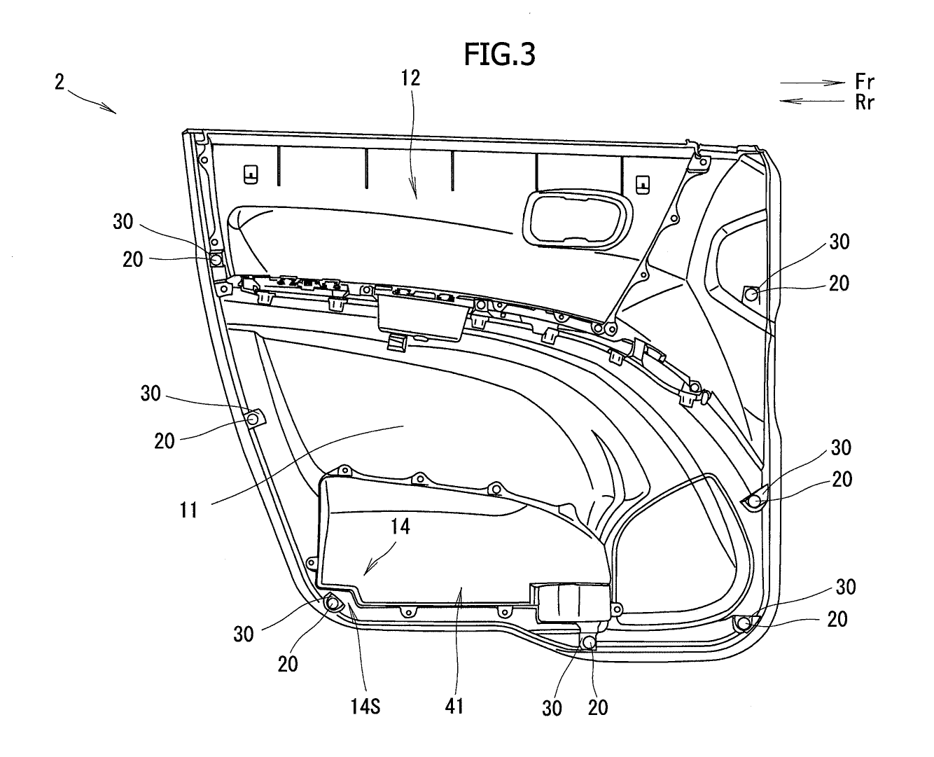

As shown in FIGS. 2 to 4, the door trim 2 includes a board 11 constituting a door trim main body, an ornament 12 serving as a decorative component (design member) which overlaps the back surface of the board 11, and an armrest 46 on which an occupant places an arm. The armrest 46 includes an armrest main body 49 formed to bulge on the inner side W1 of the vehicle compartment, and an armrest upper part 48 overlaid on the armrest main body 49 from the above. As shown in FIG. 3, a pocket member 41 is fixed to the center of a lower portion of the board 11 from the back, the board 11 located below the armrest 46. A pocket 43 (see FIGS. 2 to 4) long in a door longitudinal direction (i.e., vehicle longitudinal direction) is formed in the board 11.

All of the board 11, the ornament 12, the armrest upper part 48, and the pocket member 41 are formed of a resin. The aesthetic quality of the door trim 2 is increased by setting the colors of the board 11, the ornament 12, and the armrest upper part 48 to gray, reddish color, and bluish color, respectively. Since the ornament 12 is provided as a separate part from the board 11 as described above, this provides flexibility in adopting changes in color and specification such as top surface or painting on the design surface. Therefore, the freedom of selecting the specification is increased, and thereby the sales appeal can be improved.

In addition, multiple clip bases 30 (see FIG. 3) are distributed on the back surface (the surface opposite to the design surface) of a peripheral portion of the board 11. Thereby, the board 11 is attached to the inner panel 4 with clips 20 held by the clip bases 30. In other words, the clip bases 30 are attached to the inner panel 4 with the clips 20. The clips 20 are inserted and engaged into clip holes formed in the inner panel 4.

[Structure of Pocket 43]

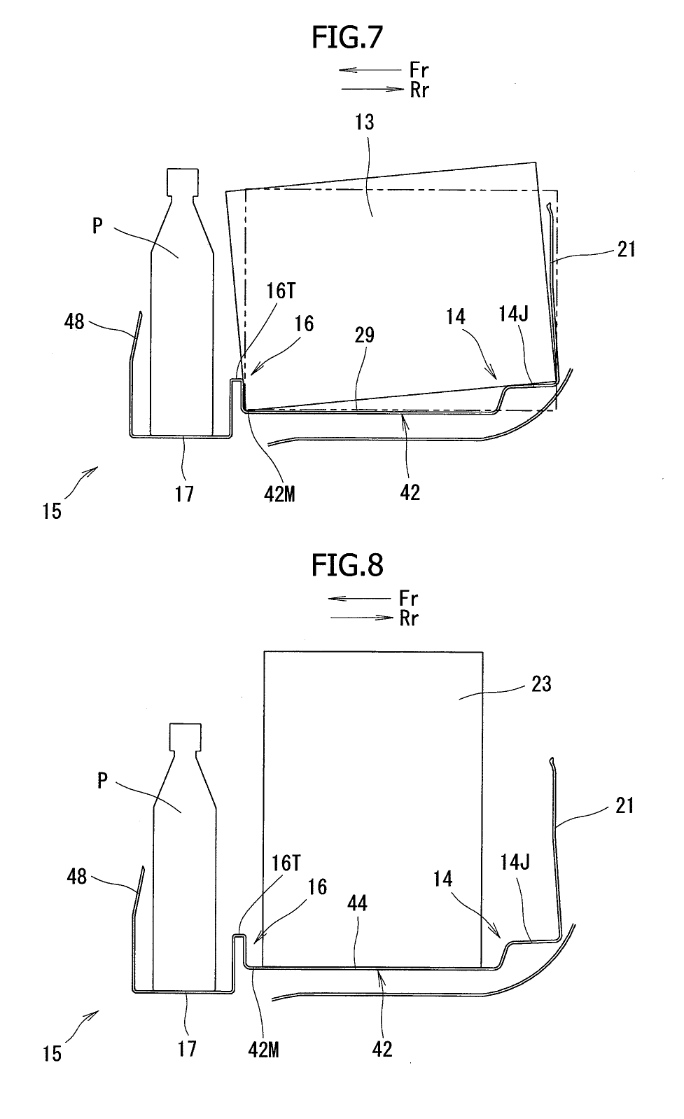

As shown in FIGS. 2 and 4, the pocket 43 is opened on an upper side thereof and formed to be long in the door longitudinal direction in such a manner as to be capable of housing a sheet shaped article 13 (see FIG. 7). Specifically, the pocket 43 is constituted of a bulging portion 37 and the pocket member 41. The bulging portion 37 is formed at the lower portion of the board 11, bulging to the inner side W1 of the vehicle compartment while being long in the door longitudinal direction. The bulging portion 37 is opened on an upper side thereof. The pocket member 41 is firmly adhered to the surface, on the outer side W2 of the vehicle compartment (i.e., the back surface) and located around the bulging portion 37, of the board 11. The pocket member 41 bulges to the outer side W2 of the vehicle compartment, and the pocket member 41 is long in the door longitudinal direction. Examples of the sheet shaped article 13 includes magazine, newspapers, maps, and A4 paper, A3 paper, and the like which are put in a bag. Articles other than the sheet shaped article 13 can be housed in the pocket 43.

Furthermore, a stepped portion 14 is formed at a rear end portion, in the door longitudinal direction (corresponding to one end portion in the door longitudinal direction), of a pocket bottom portion 42 formed by the pocket member 41. The stepped portion 14 has a longitudinal cross section in an L shape and protrudes upward. Therefore, any of the following states is compatible: a first housing state (see FIG. 7) in which the sheet shaped article 13 (for example, A4 paper) in a tilted state is horizontally placed on an upper surface 14J of the stepped portion 14 and on a front end portion 42M, in the door longitudinal direction (corresponding to the other end portion in the door longitudinal direction), of the pocket bottom portion 42; and a second housing state (see FIG. 8) in which another sheet shaped article 23 (for example, A3 paper, see FIG. 8) larger than the sheet shaped article 13 is vertically placed on the pocket bottom portion 44 but not on the stepped portion 14.

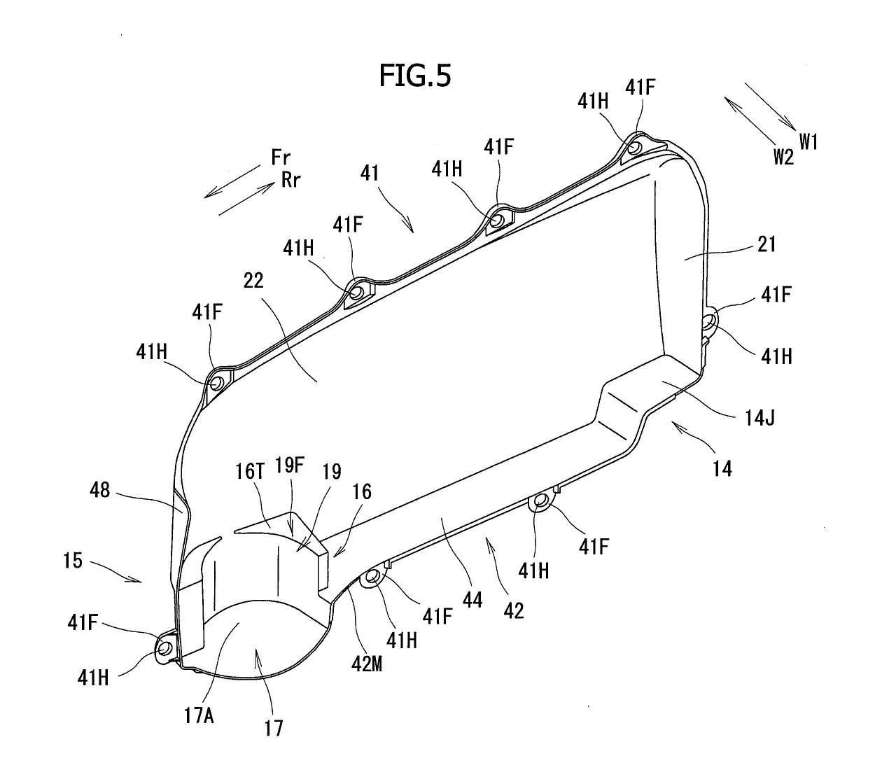

Furthermore, as shown in FIGS. 4 and 5, the front end portion 42M of the pocket bottom portion 42 is extended to a door front side Fr to form a beverage container housing portion 15. A partition wall 16 is provided upright between the beverage container housing portion 15 and the pocket bottom portion 42. The beverage container housing portion 15 is formed by butting a second vertical wall portion 36 against a first vertical wall portion 19 from the inner side W1 of the vehicle compartment. The second vertical wall portion 36 is formed at the bulging portion 37 of the board 11, and the second vertical wall portion 36 has a semi-circular horizontal cross section. The first vertical wall portion 19 has a semi-circular horizontal cross section rising from a semi-circular portion 17A, on the outer side W2 of the vehicle compartment, of a circular bottom wall 17. The bottom wall 17 and the first vertical wall portion 19 are formed in the pocket member 41.

Flanges 19F are formed from upper end portions of the first vertical wall portion 19 and the second vertical wall portion 36, and protrude outward in the radial direction. The partition wall 16 is formed by a rear half, on a door rear side Rr, of the first vertical wall portion 19 and a rear half, on the door rear side Rr, of the second vertical wall portion 36. A flange surface, facing up, of the flange 19F of the first vertical wall portion 19 and a flange surface, facing up, of the flange 19F of the second vertical wall portion 36, are positioned at approximately the same position in a vertical direction and connected to each other. The two flange surfaces form a top surface 16T of the partition wall 16. The top surface 16T of the partition wall 16 and the upper surface 14J of the stepped portion 14 are positioned at approximately the same position in the vertical direction.

An upper surface of the pocket bottom portion 42 is formed into a substantially horizontal flat surface, but the stepped portion 14 is not. A rear wall 21 (corresponding to a wall portion of the pocket 43), on the door rear side Rr, of the pocket 43, is formed by the pocket member 41, and rises from a rear end portion, in the door longitudinal direction (corresponding to one end portion in the door longitudinal direction), of the upper surface 14J of the stepped portion 14. The rear wall 21 inclines more to the inner side (i.e., the door front side Fr) of the pocket 43 at a higher position of the rear wall 21 (see FIG. 7). The rear wall 21 is covered and is hidden by the board 11 and is barely visible to the occupant. Therefore, deterioration in the appearance quality of the door trim 2 due to the inclination of the rear wall 21 can be avoided.

A front wall 48 of the pocket 43 rises from an end portion, on the door front side Fr, of the circular bottom wall 17. A square pocket side wall 22 long in the door longitudinal direction rises from a side portion, on the outer side W2 of the vehicle compartment, of the pocket bottom portion 42. The pocket side wall 22 is formed by the pocket member 41. An upper end portion of the pocket side wall 22 is positioned above the opening of the pocket 43.

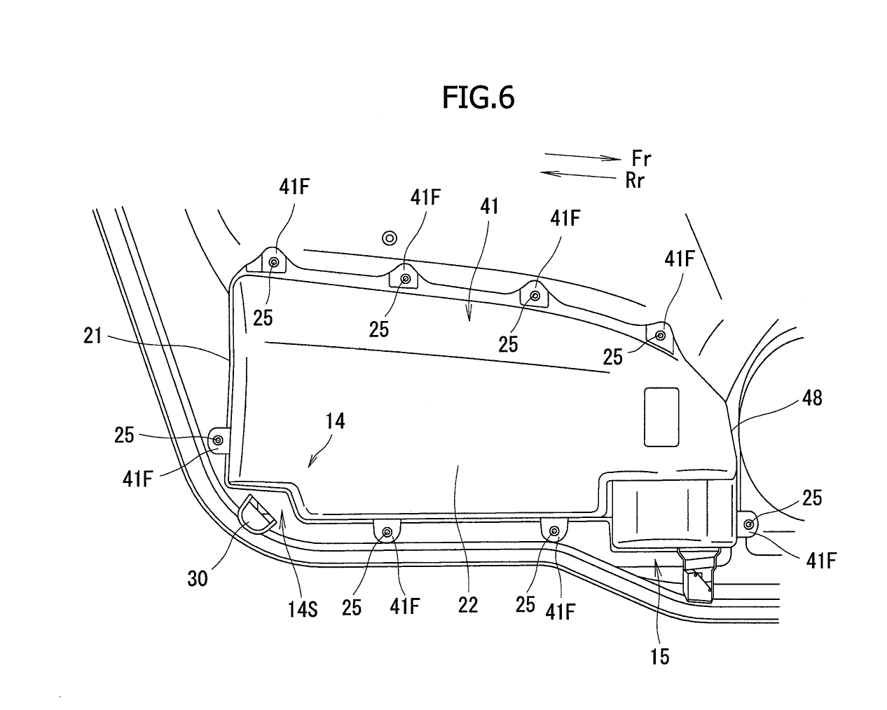

Furthermore, as shown in FIG. 5, mountain-like attachment flanges 41F are distributed on a peripheral portion of the pocket member 41, and boss insertion holes 41H are formed in the attachment flange 41F. Multiple caulking bosses 25 (see FIG. 6) protruding to the outer side W2 of the vehicle compartment from the board 11, are inserted into the boss insertion holes 41 and fixed thereto by caulking. Thereby, the pocket member 41 is firmly adhered to the board 11.

As shown in FIG. 6, a single clip base 30 among the multiple clip bases 30 is disposed in a bottom space 14S surrounded by the stepped portion 14. This clip base 30 is positioned at a corner portion, at the lowermost on the door rear side Rr, of the board 11. The clip base 30 has a clip insertion hole in a face portion formed in a top portion of a base portion that has a cross section in a U shape bulging from the back surface of the board 11.

By the above-described configuration,

(1) as shown in FIG. 7, the sheet shaped article 13 is placed on the upper surface 14J of the stepped portion 14 and on the front end portion 42M of the pocket bottom portion 42. Therefore, the sheet shaped article 13 can be housed in the tilted state in the door longitudinal direction.

For example, when a pocket structure does not include the stepped portion 14 (i.e., a structure in which the pocket bottom portion 42 is flat) and the clip base 30 is positioned close to a lower surface of the pocket bottom portion 42, in this structure, the length, in the door longitudinal direction, of the pocket 43 has to be shortened so that the pocket 43 can avoid interference with the clip base 30, or the position of the pocket bottom portion 42 has to be shifted upward to avoid the interference with the clip base 30. This brings about a problem in that the length, in the door longitudinal direction, of the housing space of the pocket 43 is shortened, and a further problem in that the height dimension of the housing space is shortened, thereby reducing the capacity of the pocket 43.

On the other hand, the above-described configuration of the present invention enables the bottom space 14S to be formed below the stepped portion 14. The clip base 30 is housed in the bottom space 14S, and the stepped portion 14 is disposed above the clip base 30. Therefore, the aforementioned problems can be avoided. The chain double-dashed line in FIG. 7 indicates the sheet shaped article 13 in a horizontal posture.

Furthermore, according to the above-described configuration of the present invention, as shown in FIG. 8, another sheet shaped article 23 larger than the sheet shaped article 13 housed in the tilted state in the door longitudinal direction can be vertically placed and housed on the pocket bottom portion 44 but not on the stepped portion 14.

That is to say, the following states are both compatible: the first housing state in which the sheet shaped article 13 is placed in the tilted state on the upper surface 14J of the stepped portion 14 and on the front end portion 42M of the pocket bottom portion 42; and the second housing state in which another sheet shaped article 23 larger than the sheet shaped article 13 is vertically placed on the pocket bottom portion 44, but not on the stepped portion 14. Furthermore, an operation to switch a part of the pocket 43 into the former state or the latter state is no longer necessary. This can reduce the tasks of the occupant.

(2) In addition, since the clip base 30 for fixing the door trim main body to the door panel 1 is disposed in the bottom space 14S surrounded by the stepped portion 14, the need to change the position of the clip base 30 in relation to the pocket 43 is eliminated, and the freedom of disposing the clip base 30 can be improved. Furthermore, by disposing the clip base 30 at the corner portion, at the lowermost on the door rear side Rr, of the door trim 2 of which lifting or the like is likely to occur, the strength of fixing the door trim 2 to the inner panel 4 can be sufficiently secured.

(3) The rear wall 21 of the pocket 43 rising from the rear end portion of the upper surface 14J of the stepped portion 14 inclines more to the inner side of the pocket 43 at the higher position of the rear wall 21. Accordingly, in a case in which the sheet shaped article 13 is housed in the tilted state in the pocket 43 as described above, the sheet shaped article 13 can be housed by guiding the sheet shaped article 13 to the rear wall 21 and along the rear wall 21. Therefore, the housing operation of the sheet shaped article 13 into the pocket 43 can be performed simply and surely.

(4) The partition wall 16 makes it possible to inhibit the movement of the sheet shaped article 13 to the beverage container housing portion 15 side. Furthermore, even in a case in which another sheet shaped article 23 having a large size is vertically placed and housed on the pocket bottom portion 44, but not on the stepped portion 14, the stepped portion 14 and the partition wall 16 can prevent movement of the another sheet shaped article 23 inside the pocket when the door is opened and closed, and when the vehicle is suddenly accelerated or decelerated.

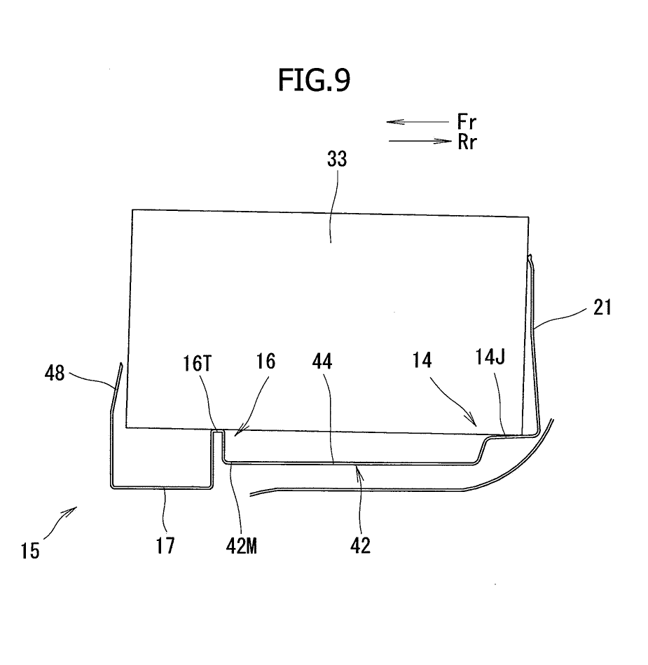

(5) As shown in FIG. 9, the top surface 16T of the partition wall 16 and the upper surface 14J of the stepped portion 14 are positioned at approximately the same position in the vertical direction. Accordingly, when a beverage container P is not housed in the beverage container housing portion 15, the housing space of the pocket 43 is increased to the beverage container housing portion 15. In a case in which a far larger sheet shaped article 33 than the another sheet shaped article 23 having a large size is to be housed, such a sheet shaped article 33 can be placed and housed in such a manner as to be bridged on the partition wall 16 and on the stepped portion 14.

For example, in a structure not including one of the partition wall 16 and the stepped portion 14, only the other of the partition wall 16 and the stepped portion 14 protrudes upward from the pocket bottom portion 42. Accordingly, the far larger sheet shaped article 33 cannot be housed stably. However, the above-described configuration of the present invention enables the far larger sheet shaped article 33 to be housed stably as described above.

### Another Embodiment

(1) The fixing portion disposed in the bottom space 14S surrounded by the stepped portion 14 is not limited to the clip base 30, and may be a caulking fixing portion or a screw fixing portion.

(2) By changing the height dimension of the stepped portion 14, the tilting angle of the sheet shaped article 13 in a housed state in the pocket 43 can be changed and adjusted.

What is claimed is:

1. A door trim comprising:
a pocket opened on an upper side thereof and capable of housing a sheet shaped article; and
a stepped portion being provided at one end portion, in a door longitudinal direction, of a pocket bottom portion, and protruding upward;
wherein a door trim is compatible with a first housing state in which the sheet shaped article is placed in a tilted state on an upper surface of the stepped portion and on the other end portion, in the door longitudinal direction, of the pocket bottom portion, and a second housing state in which another sheet shaped article larger than the sheet shaped article is vertically placed on the pocket bottom portion but not on the stepped portion.

2. A door trim according to claim 1, wherein
the stepped portion is formed to have a longitudinal cross section in an L shape, and
a fixing portion for fixing a door trim main body to a door panel is disposed in a bottom space surrounded by the stepped portion.

3. A door trim according to claim 2, wherein
the fixing portion is a clip base fixed to the door panel with a clip.

4. A door trim according to claim 1, wherein
a wall portion of the pocket rising from the one end portion, in the door longitudinal direction, at the upper surface of the stepped portion, inclines more to an inner side of the pocket at a higher position of the wall portion.

5. A door trim according to claim 1, wherein
the other end portion, in the door longitudinal direction, of the pocket bottom portion is extended in the door longitudinal direction to form a beverage container housing portion, and
a partition wall is provided upright between the beverage container housing portion and the pocket bottom portion.

6. A door trim according to claim 5, wherein
a top surface of the partition wall and the upper surface of the stepped portion are positioned at approximately the same position in a vertical direction.
